(19) United States
(12) Patent Application Publication
(10) Pub. No.: US 2019/0311732 A1
(43) Pub. Date: Oct. 10, 2019

(54) NULLIFY STUTTERING WITH VOICE OVER CAPABILITY

(71) Applicant: CA, Inc., New York, NY (US)

(72) Inventors: Lyju Rappai VADASSERY, Mumbai (IN); Vijay Shashikant KULKARNI, Bangalore (IN); Vikrant NANDAKUMAR, Bangalore (IN); Rohit PATHAK, Bangalore (IN)

(73) Assignee: CA, Inc.

(21) Appl. No.: 15/948,595

(22) Filed: Apr. 9, 2018

(51) Int. Cl. G10L 25/66; G10L 15/22

(52) U.S. Cl. CPC G10L 25/66; G10L 2015/225; G10L 15/22

(57) ABSTRACT

A system and method is described for receiving audible speech from a user and detecting stuttering by the user. A log is interrogated to determine the at least one word that is causing the stuttering. The word that is causing the stuttering is presented to the user.

### BACKGROUND

The present disclosure relates generally to personal assistant devices, and more specifically to a system and method to nullify stuttering including voice-over capability.

### BRIEF DESCRIPTION OF THE DRAWINGS

Aspects of the present disclosure are illustrated by way of example and are not limited by the accompanying drawings.

FIG. 1 illustrates a stuttering nullification system in a non-limiting embodiment of the present disclosure.

FIG. 2 is a flowchart of operations and information flows a non-limiting embodiment of the present disclosure.

FIG. 3 is a flowchart of operations and information flows for a non-limiting embodiment of the present disclosure.

FIG. 4 is a flowchart of operations and information flows for a non-limiting embodiment of the present disclosure.

### DETAILED DESCRIPTION

As will be appreciated by one skilled in the art, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus, and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

Often, people with stuttering problems face embarrassment when they are speaking to others. This experience will sometimes lead to low self-esteem and a belief that they are unable to influence others with their speaking skills during conversations or more formal presentations. This may cause their ideas and opinions to remain unexplained and/or unheard. These problems can be magnified when such individuals want to participate in public speaking or other forums where they would like to advance their ideas or opinions.

The present disclosure describes a system and method to nullify the stuttering problem of individuals with man and machine learning techniques, including the ability to voice over a user who encounters stuttering. Such systems and methods may help individuals with stuttering problems in their public speaking and/or formal presentations. The systems and methods described herein include a mobile application that has the ability to (i) understand, (ii) self-learn, and (iii) help the individual get through a presentation when stuttering occurs.

Many people with stuttering problems often get stuck with only a few words or phrases, for example, during times of anxiety. When the person is in a relaxed, friendly environment, the stuttering is substantially reduced, and may not be encountered at all. During stressful situations, however, the person may get stuck and stutter many more words. In either situation, the person may find that it is the same word(s) that cause problems with stuttering. It is also noted that people with stuttering problems are often able to ultimately pronounce the problem sounds, word(s), phrases, or sentences (“stutter words”) and complete the sentence and/or presentation when given enough time to work through the stuttering.

More particularly, the present disclosure describes a stuttering nullification system and method that includes receiving audible speech from a user and detecting stuttering by the user. A log is interrogated in order to determine the word that is causing the stuttering. The word can be presented to the user in a variety of ways. For example, in at least one nonlimiting embodiment, the word may be presented to the user at an interface and the user may be given the ability to instruct the system to voice over the speech of the user. For example, the user may use a gesture to instruct the system to voice over the speech.

Moreover, the system and method of the present disclosure may track a selected mood of the user throughout the course of a day, while the system is in a learning mode. As the system detects stuttering, the system will have the ability to determine the word that caused the stuttering, either by waiting for the user to enunciate the word properly, or by later prompting the user to input the word through an interface, for example type written. This allows the system to log words that tend to be problematic for a particular user, and also associate those logged words with a respective selected mood that had been preselected by the user before the stuttering occurred. Thus, the system is better able to predict a word that is causing stuttering in real time, by reference to the log with respect to words that caused problems in the past, and knowing the associated mood pre-selected by the user.

Practically any number and/or type of mood settings can be available for preselection by the user. For example, the mood settings may be configured along a spectrum from no stress to highest stress. However, any other type of “mood” may be selected by the user, to best inform that systems and methods described herein, the environment and mood of the user at any point in time (e.g., when stuttering is detected). Other mood types may be “anxiety mode”, “happy mode”, “dull mode”, etc. The user may also input environmental factors that may impact mood to best teach the system how to predict when stuttering will occur and how to overcome it. For example, the user may indicate “meeting mode” when the user is participating in a meeting. The user may also input the weather conditions, since these can impact mood. In this manner, the system and methods described herein may log the weather conditions at the time of stuttering (e.g., sunny, cloudy, rain, snow, cold, hot) and/or the season of the year, to help the system better predict when stuttering may occur and the stutter words causing it.

It should also be noted that the systems and methods described herein may also use the time of day to predict the mood of the user at any given time. For example, the system may identify a mood pattern (e.g., person is most stressed during the afternoons, Monday thru Friday) and use that to interpolate the mood setting. In this manner, the system may log the time of day, and day in the log 120 in order to best learn and predict when stuttering may occur and how best to overcome it.

When the system detects stuttering, it can use whatever information it can collect regarding the word (e.g., portion of the word or sounds that are spoken coherently) along with additional information from the log (the same or similar words that caused stuttering in the past and the mood associated with such words) to predict which word or words the user is trying to convey.

Thus, the system is better equipped to use artificial intelligence, machine learning and/or data analytics and order to quickly identify any word that is causing a stuttering problem for a user, present that word to the user, and/or provide the user with the ability to instruct the system to voice over the problematic word on behalf of the user. This can be particularly useful in a large group setting for example a speech or any situation in which the user is concerned that stuttering is likely to occur and will result in a delay in the user's ability to convey a message.

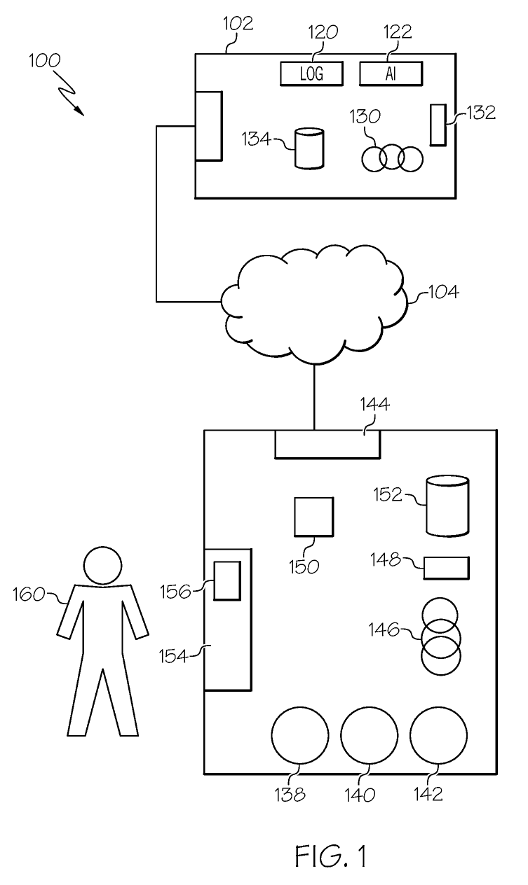

FIG. 1A illustrates a stuttering nullification system 100 in a non-limiting embodiment of the present disclosure. The system 100 may include a server 102, a network 104, and a mobile device 106. In some embodiments, the server 102 may be combined with the mobile device 106 and/or some or all of the features and functions of the server described herein may be incorporated into the mobile device 106. Similarly, any of the features or functions described herein as being incorporated into mobile device 106 may be incorporated, in part or in full, into server 102.

The server 102 may be located on the cloud, on an external network, or on an internal network. In some non-limiting embodiments, the server 102 may be partially located on a mobile device 106 and partially on the cloud or a network (e.g., network 104), or any combination thereof. Furthermore, some non-limiting configurations of the server 102 may be located exclusively on the mobile device 106. The server 102 may be accessed by the mobile device 106 either directly, or through a series of systems configured to facilitate the systems and methods described herein, using communications to and from the server 102.

Network 104 may comprise one or more entities, which may be public, private, or community based. Network 104 may permit the exchange of information and services among users/entities that are connected to such network 104. In certain configurations, network 104 may be a local area network, such as an intranet. Further, network 104 may be a closed and/or private network/cloud in certain configurations, and an open network/cloud in other configurations. Network 104 may facilitate wired or wireless communications of information and provisioning of services among users that are connected to network 104.

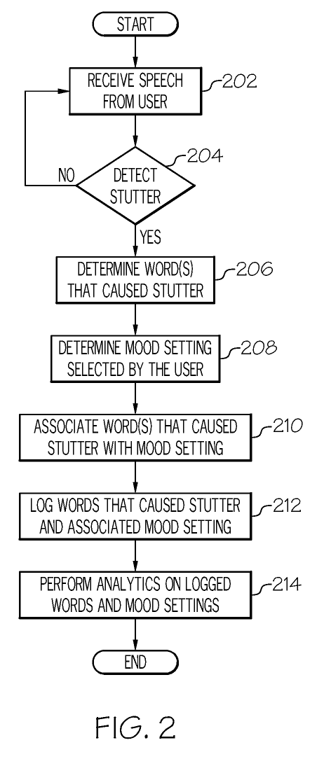

The mobile device 106 of the system 100 may be connected to the server 102 through the network 104. The mobile device 106 may support user stuttering nullification and logging of data, in conjunction with the server 102, and/or other servers or systems in communication with network 104. The operation of the mobile device 106 is further described in FIGS. 2-4.

The server 102 may include a processor 130, volatile memory 132, a hard disk or other non-volatile storage 134, and an interface 136. The server 102 may be connected to the mobile device 106 through a network 104. Server 102 may also include any number of applications that accommodate some or all of the features disclosed herein. By way of example, FIG. 1 illustrated a log 120 (e.g., a computer database) for storing stutter sounds, words, phrases, sentences, etc. along with their associated preselected mood settings, as described more fully later. As another example, FIG. 1 illustrates an artificial intelligence module 122 that can be used to accomplish some or all of the data analytics, machine learning and artificial intelligence functionality described herein. It will be recognized by those of ordinary skill in the art that such applications and modules (e.g., log 120 and artificial intelligence module 122) may be incorporated into server 102, mobile device 106, or both.

The mobile device 106 may include a plurality of applications 138-142, a network interface 144, a processor 146, volatile memory 148, input/output devices 150, hard disk or non-volatile storage 152, and a user interface 154 that may comprise a keyboard, mouse, monitor, microphone, speaker 156 and any other hardware and/or software that allows a user 160 to communicate with the mobile device 106.

FIG. 2 illustrates a method for stuttering nullification, in accordance with a particular embodiment of the present disclosure. The method begins at step 202, where the system receives speech from a user. For example, this may include a mobile device or telephone carried by the user in which the user initiates an application that will listen to speech from the user. At step 204, the system detects stuttering by the user. If no stutter is detected, the device will continue to receive and analyze speech from the user in an effort to detect stuttering. However, if stuttering is detected at step 204, at step 206 the system will attempt to determine the word, words, phrases, and/or sentences that are causing the stutter.

There are several ways in which the system can attempt to determine words that cause the stutter. For example, the system may be able to detect or understand certain letters, sounds, partial words, or several words of an incomplete sentence spoken by the user, that precede and/or occur concurrent with the stutter. This information can help the system determine the word, words, phrases, or sentences that are causing the stuttering. In certain embodiments, the system may use sounds, a word or words, phrases, or sentences that occur after the stutter to determine which word caused the stutter.

For example, often times a user who stutters will, after a period of time, be able to speak the word that was causing the stutter, effectively. In this embodiment, the system uses the properly spoken word to understand that it was causing the stutter. In another embodiment, the system may determine that the user opted for an alternative word, to avoid the stutter. For example, the user may opt for a synonym of the word that caused the stutter. The use of a synonym or an alternative word may provide the system with the ability to determine the word that cause the stutter, even if the user never actually speaks the word. In some embodiments the system may not be able to determine, with sufficient certainty, the sound, word, words, phrases, and/or sentences that cause the stuttering. In such a case, the system may present a user with the ability to input the word that caused the stuttering. For example, the system may request that the user type in the word that the user was unable to speak, in order for the system to understand the word the caused the stutter.

In some embodiments, in order to help the user in this regard, the system will provide the user with a written transcript of the word, words, phrases, and/or sentences that occurred before, and optionally words that occurred after (if any) to assist the user in understanding where the stutter occurred and help the user understand which word or words the system was unable to understand that caused the stutter.

At step 208, the system determines a mood setting selected by the user. The mood setting is one that may be pre-selected by the user and indicate the mood of the user at any given time.

For example, the mood settings may range from a relaxed mood to a high stress mode. If the user is in a happy mood, with no reason to exhibit stress, the user may select a happy mode, or low stress mode. Alternatively, if the user is in a high stress situation, for example working under a particular deadline or presenting a speech to an audience, the user may select a high stress mode. Understanding the mood of the user at any given time when a stutter occurs will help the system to learn and understand any particular words that are more likely to lead to a stutter during a time at which the user is in any particular mood.

For example, it is likely that a user in a high stress situation (presenting to a group of executives at a meeting), is likely to be using words that are different than those used by her in every day conversation with coworkers. In addition, it is often more likely that a user will stutter in a high stress situation and less likely that the user will stutter in a low stress situation. The system is able to use the mood setting that had been preselected by the user prior to the stutter to associate the mood with any particular word, words, phrases, and/or sentences that caused the stutter. By storing such words, with the associated mood pre-selected by the user, the system is better able to predict which words a user is likely to struggle with, or is struggling with in real time, based at least in part upon a mood that had been preselected by the user at the time that the stutter occurred. Thus, at step 210 the system associates the word or words that cause the stutter with the mood setting in operation at that time.

At step 212, the system logs the words that cause the stutter and the associated mood setting, for future reference. All of the interaction and information collected by the system described above can be used to perform analytics on the stored data, for example to accomplish machine learning or use artificial intelligence to improve the system's ability to predict stuttering in the future, and/or to predict a particular word or words that are causing stuttering in real time, in the future. Such analytics on the log words and associated mood settings are performed at step 214.

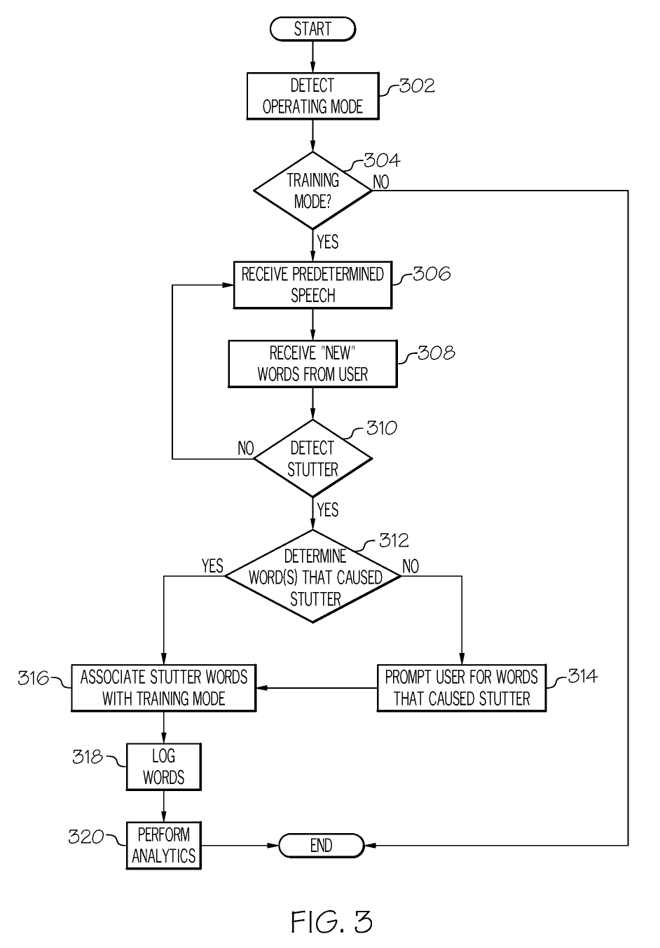

FIG. 3 illustrates a method for stutter nullification, in accordance with an alternative embodiment of the present disclosure. The method begins at step 302 where the system determines the current operating mode that the system is operating under. For example, the system and methods described herein may provide the user with ability to select between one of a plurality of different operating modes. For example, the modes described in FIG. 2 may be referred to as a learning mode, wherein the user carries the device on a day-to-day basis and provides the system with the opportunity to learn which words cause stutter and which moods are associated with those words. This allows the system to perform artificial intelligence, machine learning and data analytics for better future prediction. Alternatively, FIG. 3 as will be described in more detail below refers to a training mode, in which a user will attempt to train the system to better assist with a predetermined speech, or in an environment or setting in which the user anticipates using certain pre-define words, phrases, and/or sentences.

Thus, at step 304 the system determines whether it is in training mode. If the system determines that it is not in training mode, the method ends. However if the system determines that it is in training mode, it will begin to receive a predetermined speech from the user, for example, at step 306. In certain embodiments, the user may have a pre-written speech that the user will be required to deliver to a group of people at a meeting or seminar. In this case the user may opt to select a training mode for the system and practice reading into the system, the predetermined speech.

At step 308, the system may optionally receive new words from the user. For example, the user may know that the user will be required to speak certain words that the user has not used in a widespread manner in the past. A predetermined speech may have long or complex words that the user is anticipating potential trouble with during the presentation. However, this step is optional and only used to help the system better anticipate and predict words that are causing stuttering during the speech that occurs in the training mode. At step 310 the system determines whether or not a stutter is detected. If no stutter is detected, the system will simply continue to receive the predetermined speech at step 306.

At step 312 the system will attempt to determine the sound, word, words, phrases and/or sentences that are causing the stutter. If the system is unable to make such determination, the system may optionally prompt the user to input the words that cause the stutter, as described above with regard to FIG. 2.

If the system is able to determine the word that caused the stutter, or receives an identification of such words from the user, the system may associate the words that cause the stutter with a training mode for purposes of the log, at step 316. Knowing that the user was operating in a training mode at the time of the stutter will suggest to the system that this was a practice setting and likely a somewhat stressful situation for the user attempting to read a predetermined speech. Either alternatively or in addition to associating the words that cause the stuttering with training mode, the system may determine a mood setting that has been preselected by the user during the training mode and associate the mood setting with the words because the stutter. For example, even within the training mode, a user may experience different moods and/or different levels of stress or anxiety and therefore inputting the mood setting into the system may help better teach the system to better predict a word or words likely to cause stutter or causing stutter in real time.

At step 318 words that caused stuttering are logged, and may be associated with training mode generally, or more particularly with a specific mood setting that had been preselected by the user at the time that the stuttering occurred. Similar to the method described above with regard to FIG. 2, the system may perform analytics at step 322, employ artificial intelligence, machine learning, and/or data analytics to teach the system the better predict words that may cause stuttering and/or causing stuttering in real time.

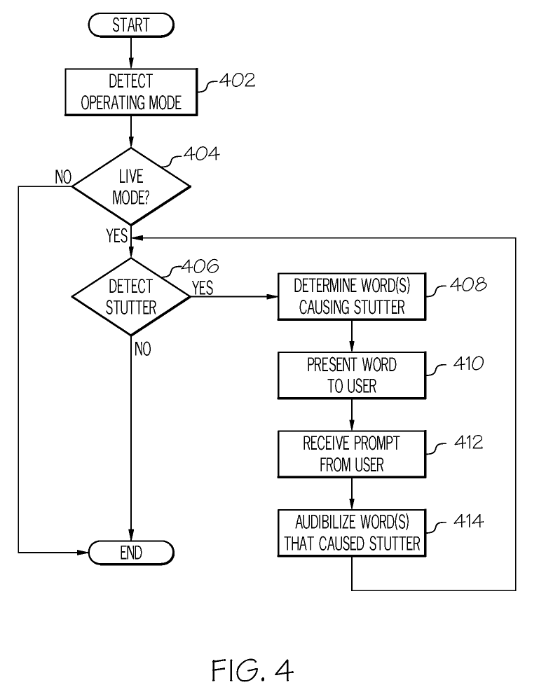

FIG. 4 illustrates a method for stutter nullification in accordance with an alternative embodiment of the present disclosure. The method begins at step 402 where the system detects the operating mode that is currently selected. For example, as described with respect to FIGS. 2 and 3, respectively, the system may detect a training mode, or a learning mode. FIG. 4 describes the features and functions of a “live” mode.

The live mode generally describes the mode of operation where a user is seeking assistance from the system in real time, with regard to a communication by the user. For example, after using the learning mode and/or the training mode, the user may select live mode at the time that a speech or presentation is being given. In certain embodiments, the live mode is the mode in which the system will assist the user when a stutter is detected.

Thus, at step 404, the system determines whether it is operating in a live mode. If it is not operating in a live mode, the method ends. However, if the system determines that it is operating in a live mode, it will receive speech from the user and detect stuttering, for example at step 406.

As described above, when a stutter is detected, the system will attempt to determine the word or words that are causing the stuttering. In the live mode, it is more likely that the system will rely upon prior logs, prior stutter words and associated mood settings, artificial intelligence, machine learning, and/or data analytics to determine the words that are causing the stuttering at step 408.

If the system is able to determine the word or words causing the stuttering, the word is presented to the user at step 410. The word may be presented to the user in a number of different ways. For example, it may be presented to the user visually, and this may help some overcome a stutter. In another embodiment, it may be presented to the user audibly in a manner that only the user can detect, for example in an earphone. In yet another embodiment, the word may be presented to the user over a speaker and potentially a loudspeaker that will allow others in the room to hear the word. This has the advantage of allowing the system to speak on behalf of the user. For example, if the user reaches a point in the speech or presentation where stuttering is occurring, rather than having to wait until the user can collect herself sufficiently to say the word coherently, the system may automatically speak over the user such that others in the room can hear the word, and the user can move on. Alternatively, the system may wait for a prompt from the user at step 412 before speaking the word out loud at step 414. For example, in particular embodiments, the system may present the word to the user or present the user with some indication that the system has detected stuttering and predicted the word that is causing the stuttering, but will wait for input from the user before presenting the word to the room. The system can be configured in a variety of different ways to allow the user to communicate to the system that the user would like the system to speak the word out loud. For example, it may be a simple gesture, for example movement detected by an Apple Watch. In another embodiment the user may press a preselected button, key or other indication to the system to speak the word out loud.

The flowchart and block diagrams in the figures illustrate examples of the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order illustrated in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” or “/” includes any and all combinations of one or more of the associated listed items.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method, comprising:
receiving audible speech from a user;
detecting stuttering by the user;
interrogating a log to determine the at least one word that is causing the stuttering by the user; and
in response to determining the at least one word that is causing the stuttering, presenting the at least one word that it is causing the stuttering to the user.

2. The method of claim 1, wherein presenting the word to the user comprises audibly presenting the word to the user through a speaker.

3. The method of claim 1, wherein presenting the word to the user comprises:
receiving a prompt from the user to present the word audibly; and
in response to receiving the prompt, audibly presenting the word to the user through a speaker.

4. The method of claim 1, wherein:
the log comprises a plurality of stutter words that have caused user to stutter in the past, the plurality of stutter words comprising the at least one word that is causing the stuttering;
each of the stutter words are associated with a respective one of a plurality of mood settings; and
each respective one of the plurality of mood settings comprises a mood setting pre-selected by the user and being in operation at a time that the respective stutter word caused the user to stutter in the past.

5. The method of claim 4, wherein the pre-selected mood setting is pre-selected by the user from among a plurality of mood settings that represent different levels of stress that the user is anticipating being under.

6. The method of claim 5, wherein the plurality of mood settings range from a relaxed mood setting to a high stress mode setting.

7. The method of claim 1, wherein the at least one word that is causing the stuttering comprises at least a second word and wherein detecting the stuttering comprises detecting a second stuttering, and further comprising:
detecting a first stuttering by the user;
determining the at least a first word that is causing the first stuttering;
determining a preselected mood setting in operation at a time that the first stuttering by the user occurred;
associating the at least a first word with the pre-selected mood setting; and
storing the at least a first word and the associated preselected mood setting in the log.

8. The method of claim 7, wherein determining the at least a first word that is causing the first stuttering comprises prompting the user to identify the at least a first word that is causing the first stuttering.

9. The method of claim 1, wherein prior to receiving the audible speech, the method further comprises:
prompting the user to enter any new words that are expected to be included in the audible speech;
receiving the new words; and
storing the new words in the log.

10. The method of claim 7, wherein the preselected mood setting is selected from a plurality of mood settings that range from a relaxed mood setting to a high stress mode setting.

11. A computer configured to access a storage device, the computer comprising:
a processor; and
a non-transitory, computer-readable storage medium storing computer-readable instructions that when executed by the processor cause the computer to perform:
receiving audible speech from a user;
detecting stuttering by the user;
interrogating a log to determine the at least one word that is causing the stuttering by the user; and
in response to determining the at least one word that is causing the stuttering, presenting the at least one word that it is causing the stuttering to the user.

12. The computer of claim 11, wherein presenting the word to the user comprises audibly presenting the word to the user through a speaker.

13. The computer of claim 11, wherein presenting the word to the user comprises:
receiving a prompt from the user to present the word audibly; and
in response to receiving the prompt, audibly presenting the word to the user through a speaker.

14. The computer of claim 11, wherein:
the log comprises a plurality of stutter words that have caused the user to stutter in the past, the plurality of stutter words comprising the at least one word that is causing the stuttering;
each of the stutter words are associated with a respective one of a plurality of mood settings; and
each respective one of the plurality of mood settings comprises a mood setting pre-selected by the user and being in operation at a time that the respective stutter word caused the user to stutter in the past.

15. The computer of claim 14, wherein the pre-selected mood setting is pre-selected by the user from among a plurality of mood settings that represent different levels of stress that the user is anticipating being under.

16. The computer of claim 14, wherein the plurality of mood settings range from a relaxed mood setting to a high stress mode setting.

17. The computer of claim 11, wherein the at least one word that is causing the stuttering comprises the at least a second word and wherein detecting the stuttering comprises detecting a second stuttering, and wherein the computer-readable instructions, when executed by the processor, further cause the computer to perform:
detecting a first stuttering by the user;
determining the at least a first word that is causing the first stuttering;
determining a preselected mood setting in operation at a time that the first stuttering by the user occurred;
associating the at least a first word with the pre-selected mood setting; and
storing the at least a first word and the associated preselected mood setting in the log.

18. The computer of claim 17, wherein determining the at least a first word that is causing the first stuttering comprises prompting the user to identify the at least a first word that is causing the first stuttering.

19. The computer of claim 11, wherein the computer-readable instructions, when executed by the processor, further cause the computer to perform, prior to receiving the audible speech:
prompting the user to enter any new words that are expected to be included in the audible speech;
receiving the new words; and
storing the new words in the log.

20. A computer program product comprising:
a computer-readable storage medium having computer-readable program code embodied therewith, the computer-readable program code comprising:
computer-readable program code configured to receive audible speech from a user;
computer-readable program code configured to detect stuttering by the user;
computer-readable program code configured to interrogate a log to determine the at least one word that is causing the stuttering by the user;
computer-readable program code configured to, in response to determining the at least one word that is causing the stuttering, present the at least one word that it is causing the stuttering to the user;
wherein presenting the word to the user comprises audibly presenting the word to the user through a speaker;
computer-readable program code configured to receive a prompt from the user to present the word audibly; and
computer-readable program code configured to, in response to receiving the prompt, audibly present the word to the user through a speaker.
